(19) United States
(12) Patent Application Publication
(10) Pub. No.: US 2008/0054597 A1
(43) Pub. Date: Mar. 6, 2008

(54) Resilient Skid Plate

(76) Inventor: Chris Becker, Denver, CO (US)

Correspondence Address: Leyendecker & Lemire, LLC, C/O PORTFOLIO IP, P.O. BOX 52050, MINNEAPOLIS, MN, 55402, US

(21) Appl. No.: 11/469,065

(22) Filed: Aug. 31, 2006

(51) Int. Cl. B62J 27/00

(52) U.S. Cl. 280/304.3

(57) ABSTRACT

An embodiment of a vehicle skid plate comprises a pivot mechanism typically comprising either the resilient plate itself or a hinge, the pivot mechanism being adapted to couple to a vehicle and provide protection to the vehicle's rear suspension linkage. The skid plate may also protect the vehicle frame rails, undercarriage, and downtube, among other vehicle components. The linkage is protected typically by the skid plate substantially continually contacting at least a portion of the linkage. The skidplate may also incorporate a hinge.

### FIELD OF THE INVENTION

This invention generally relates to vehicle skid plates.

### BACKGROUND

Modem off-road motorcycles and motocross racing have their origins in World War II-era motorcycles. Many motorcycles during WWII had large tires and were developed for use over semi-rough terrain, such as rough dirt roads. Although prior to WWII there were races such as the International Six Days Trial, begun in 1913, it was not until the late 1940s, when these motorcycles used during the war began to be outfitted solely as off-road bikes, did the sport of off-road cycling take off. The WWII-era motorcycles, among them models developed by BMW, BSA, Norton, and Triumph, were easily equipped for full-time use in off-road racing events. However, these early off-road machines were incredibly primitive by today's standards. They were heavy, underpowered, and fitted with rudimentary suspension systems that did little to smooth out the rough terrain.

Over time, motorcycles were developed to withstand prolonged off-road usage and allow users to ride off-road cycles for prolonged periods of time. For example, the motorcycle chassis and frames of today are designed from welded aluminum or steel (possibly being an alloy) struts that ensure the rear suspension is an integral component in the frame design. Carbon-fiber may be used in very expensive custom frames. Additionally, some current motorcycles include the engine as a load-bearing (or stressed) member; this has been used throughout motorcycle history but has now seemed to become more common.

The front suspension of modern cycles generally consists of a fork, comprising sliding steel tubes with long springs inside, which also use hydraulic fluid to create shock absorbers. The rear suspension supports a swingarm, which is a suspension component attached to the frame via a pivot bolt that holds the rear wheel axle. The rear suspension also consists of a shock arrangement. One type of shock arrangement is a traditional monoshock a suspension system placed at the front of the swingarm, above the swingarm pivot bolt. Suspension components located proximate the pivot bolt and swingarm is called the linkage.

No matter the type of vehicle employed in off-road riding (such as motorcycles or other off-road vehicles such as all-terrain-vehicles, or “ATVs”), the frame rails, undercarriage, and linkage are subject to extreme wear and tear. One aspect of this wear and tear is the scraping and build-up of dirt and mud in the undercarriage and linkage of the bike. In an attempt to minimize this wear and tear, motorcycles typically come with factory-mounted skid plates coupled to the undercarriage and front frame rails of the vehicle to protect the frame rails and casing from destruction and to minimize wear and tear. Typical prior art skid plates are designed to protect against scraping the frame and engine components when casing a jump, or to keep mud and dirt from destroying the engine. Similarly, prior art protection systems such as described in U.S. Pat. No 6,042,171 protect the front of the bike from the wear and tear of projectiles and to protect the bike from dirt and mud on forward-facing engine components.

Prior art skid plates and protection systems arc deficient in that they typically add a significant amount of weight to the bike, which, during racing and motocross competitions, is typically sought to be minimized. Additionally, prior art skid plates are difficult to clean, being comprised of aluminum or steel alloy and having multiple bores through the skid plate that dirt and mud can pass through. They are also unable to be used as an adequate advertising mechanism. Lastly, prior art skid plates do not protect the rear suspension linkage, which can be one of the component areas that suffers the most wear and tear and is of the most difficult to adequately clean.

### SUMMARY OF THE DRAWING

FIG. 1 is an isometric view of one embodiment of the invention.

FIG. 2 is an isometric view of a portion of one embodiment of the invention coupled to a vehicle.

FIG. 2A is a close-up transparent isometric view of a portion of one embodiment coupled to the downtube and frame rails of a vehicle.

FIG. 3 is an isometric view of the distal portion and part of the center portion of one embodiment of the invention coupled to a vehicle.

FIG. 4 is a top view of one embodiment of the invention.

FIG. 5 is an isometric view of one embodiment of the invention coupled to a vehicle.

FIG. 5A is a top view of one embodiment of the invention.

FIG. 6 is an isometric view of the distal portion and part of the center portion of one embodiment of the invention.

FIG. 7 is a side view of one embodiment of the invention coupled to a vehicle.

### DETAILED DESCRIPTION

An embodiment of the present invention is adapted to protect the rear suspension linkage. An embodiment is also adapted to protect the undercarriage, frame rails, and downtube of a vehicle such as a motorcycle, although an embodiment may also be adapted for use as a linkage skid plate on additional vehicles such as, but not limited to, ATVs.

One embodiment is comprised of a pivot mechanism. The pivot mechanism may be comprised of a unitary piece of thin resilient polymer, that, when attached to a vehicle, extends from the vehicle frame to a position proximate the rear suspension linkage, ending before the rear wheel. An embodiment may not be comprised of a single unitary skid plate, but may be comprised of a plurality of components, such as, but not limited to, a hinge pivot mechanism. Additionally, an embodiment is contemplated that is not comprised of a thin resilient polymer, but is comprised of a more rigid material such as, but not limited to, an aluminum composite or a carbon fiber composite material. Embodiments comprising of a unitary resilient polymer are typically generally 1/10 of an inch thick. Embodiments comprising different materials or multiple components may be of greater or lesser thickness, with one preferred greater thickness being ¼ of an inch thick and one preferred lesser thickness being 1/16 of an inch thick.

A first embodiment typically comprises a unitary thin resilient polymer having an embodiment distal portion, an embodiment center portion, and an embodiment proximal portion. The distal portion is typically integrated to the center portion, with the center portion also typically being integrated to the proximal portion. The distal portion typically terminates in a distal end. When placed on a vehicle, the distal portion and center portion are typically adapted to integrate at a position proximate a rear vertical frame rail or rear horizontal frame rail, the distal portion extending rearwardly from the center portion integration towards the rear wheel.

A second embodiment is contemplated as having a single portion, the single portion being similar to the distal portion of the first embodiment. A single portion embodiment is typically coupled to the vehicle frame proximate the rear vertical frame rail or rear horizontal frame rail and extends rearwardly from the vehicle frame to a position proximate the rear wheel.

In the first embodiment and second embodiment, each embodiment is adapted to protect the rear suspension linkage, typically by resiliently deforming relative to the linkage position. For example, in one embodiment, at least a part of the distal portion, or a part of the single portion, substantially continually contacts a portion of the rear suspension linkage. In such an embodiment, as the rear suspension linkage moves in a substantially vertical direction along rough or semi-rough terrain, at least part of the distal portion or at least a part of the single portion keeps substantial continual contact with the rear suspension linkage. Substantial continual contact between the linkage and the skid plate occurs by the resiliency of the skid plate adjusting the portions' position relative to the position of the linkage. In one embodiment, therefore, the linkage is typically protected from rocks, dirt, and debris, before, during, and after linkage movement. One embodiment, therefore, typically reduces the wear and tear on the linkage and reduces the time required to clean the linkage after a riding session.

An embodiment may possess varying width to protect the linkage, undercarriage, frame rails, and downtube. For example, an embodiment may be comprised of a distal or single portion that is tapered. The average width of a tapered distal portion is typically less than the width of the center portion. The width of the tapered distal portion is typically greatest where the distal portion is integrated to the center portion and smallest at a distal end. A tapered distal or single portion width may provide the skid plate with a decorative look or may enable a user to adjust any linkage parts without removing the skid plate from the vehicle, as well as provide additional benefits.

The distal portion and single portion are typically adapted to couple to a rear horizontal frame rail proximate a rear vertical frame rail. The coupling position is adapted to allow an embodiment to pivot at the coupling point to allow movement of the distal or single portion relative to the position of the linkage.

Typically, the center portion of an embodiment is generally as wide as the casing frame rails. The center portion extends from the distal portion integration, which, when the embodiment is placed on a vehicle is adapted to be located proximate the rear vertical frame rails, to the proximal portion integration. The center portion and proximal portion integration is adapted to be located at a location proximate the front vertical frame rails. The proximal portion is generally adapted to be as wide as the front vertical frame rails and the downtube, when an embodiment is placed on a vehicle.

Embodiments are typically coupled to the vehicle via vehicle attachment mechanisms, which are typically adapted to couple to vehicle mounting points. Vehicle mounting points are usually located on the vehicle frame. A single portion embodiment may couple to the vehicle using only two vehicle attachment mechanisms, whereas an embodiment having a center portion and a proximal portion may couple to six, eight or even ten or more vehicle attachment mechanisms. Embodiments incorporating a hinged section as described below may couple to four, six, eight, or ten or more vehicle attachment mechanisms.

### Terminology:

The terms and phrases as indicated in quotation marks (“”)in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “resilient” or any version thereof implies a resistance of permanent plastic deformation in a non-rigid article or structure wherein the article is capable of resuming and recovering its original size and shape after being readily bent, stretched, expanded, or contracted. Furthermore, a “resilient” article will flex or elastically bend or deform a substantial and significant amount when subject to typical loads. By contrast, “rigid” refers to an article that is relatively inflexible or resistant to elastic deformation when typical loads are applied. “Semi-rigid” refers to an article that will elastically deform a moderate amount under typical loads. Resiliency is generally dependent on the dimensions or structure of an article as well as the material properties of the article's constituent material(s). Resiliency may also be dependent on the nature of loading of an article. For instance, a thin plastic plate may be very resilient to loads induced perpendicular to the plane of the plastic but generally rigid to loads applied parallel to the plane. It is to be appreciated that the characteristic of an article being “resilien”, “rigid” or “semi-rigid” as used herein is to be assessed relative to the angle and magnitude of loads applied to a vehicle skid plate during typically and customary use, as well as the thickness of the skid plate.

The term “pivot mechanism” of any version thereof refers to a feature of a skid plate which enables at least a portion of the skid plate to change its position relative to the position of a vehicle's rear suspension linkage. For example, one embodiment's pivot mechanism may be a hinge. An embodiment may also be comprised of a pivot mechanism which is comprised of a resilient material coupled to the vehicle frame in a manner adapted to allow the skid plate to generally recover its original shape.

The term “composite”, “composites” or any version thereof refers to a solid material which is composed of two or more substances having different physical characteristics and in which each substance retains its identity while contributing desirable properties to the whole; such as, but not limited to, a structural polymeric matrix within which a fibrous material such as silicon carbide is embedded.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least one embodiment of the invention. The appearances of phrases such as “in one embodiment”, “in an embodiment”, or “in a variation” in various places in the specification are not necessarily meant to refer to the same embodiment or variation.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of ±20%. Also, as applicable, the term “substantially” as used herein unless otherwise indicated means a margin of ±10%. It is to be appreciated that not all uses of the above terms are quantifiable such that the referenced ranges can be applied.

The term “integrate” or “integrated” as used in this specification and the appended claims refers to a blending, uniting, or incorporation of the identified elements, components or objects into a unified whole.

### First Embodiment of a Vehicle Linkage Skid Plate

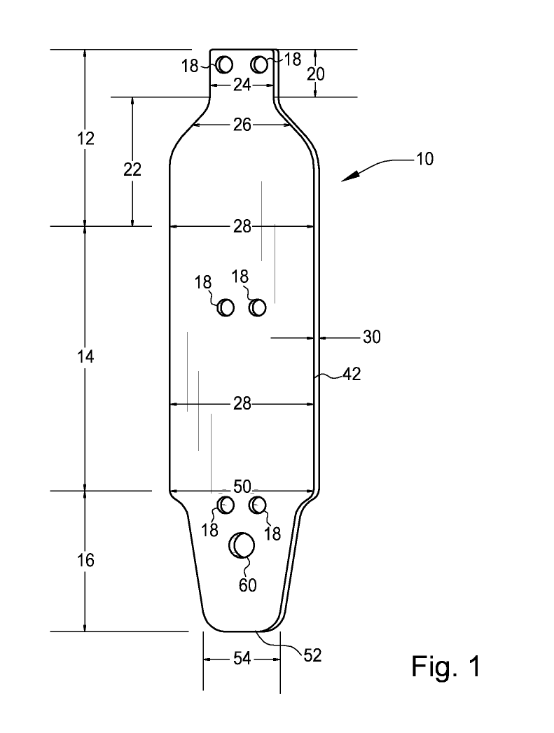

Referring to FIGS. 1 to 3, 6 and 7, an embodiment of a vehicle linkage skid plate 10 is illustrated. In one embodiment, the skid plate is comprised of a proximal portion 12, a center portion 14, a distal portion 16, and a plurality of vehicle attachment mechanisms 18.

Generally, one embodiment is adapted to protect at least a portion of the undercarriage 32, linkage 34, swingarm 36, and frame 38 of a vehicle, as well as the chain roller 35 and chain 37, among other components, from mud, dirt, and debris build-up that occurs while riding an off-road vehicle. The embodiment is also adapted to protect these areas, among others, from the normal wear and tear of off-road racing, such as, but not limited to, scratches and mechanical failures. A typical vehicle that an embodiment is adapted to be used thereon is a motorcycle, although on embodiment may be used on other vehicles such as, but not limited to, ATVs.

In one embodiment, the proximal portion 12 is comprised of a downtube section 20 and a frame rail section 22. Typically, the downtube section is generally adapted to provide protection to the downtube and the frame rail section is generally adapted to protect the frame rails. Therefore, the width 24 of the downtube section is typically adapted to generally equal the width of the downtube of a motorcycle or other vehicle. In one embodiment, only a portion of the downtube is protected with the skid plate, although in other embodiments, substantially the entire downtube is protected with the skid plate 10.

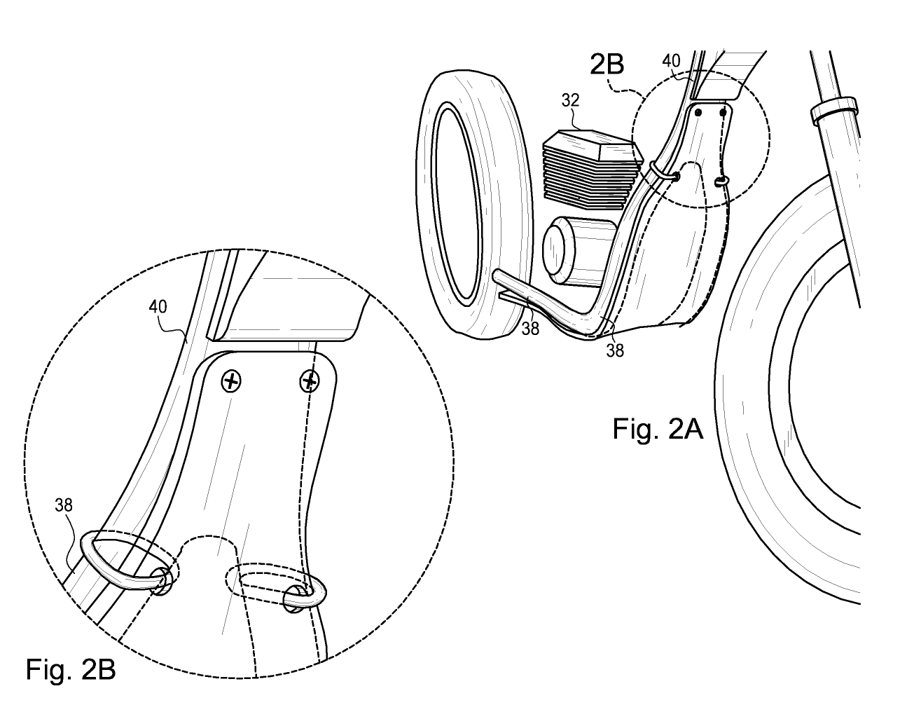

Like the downtube portion, typically, the width of the frame rail section 22 of the proximal portion 12 in one embodiment is generally equal to the width of the front frame rails on a vehicle. The expansion width 26 of the frame rail section is initially generally equal to the downtube section where the frame rail and downtube are integrated. However, as best shown in FIGS. 1, 2, and 2A, the width of the frame rail section widens as the distance from the down tube section 20 increases. The final width of the frame rail section is a maximum width 28.

Once the maximum width 28 is reached, the maximum width typically remains generally uniform throughout the proximal portion 12 to the center portion 14 integration. However, in one embodiment, the maximum width may increase or decrease in order to adapt to the width of the frame rails 38 on the undercarriage 32 or the front of the vehicle, or to protect other vehicle components, or for other non-vehicle protection reasons. The width of all portions—proximal 12, center 14, and distal 16, and all sections within any portion, may be adjustable. In one embodiment, a user may adjust the widths of the separate portions to align the individual portions with the outer edges of the individual's downpipe 40, frame rails 38, linkage 34, or other vehicle components.

One embodiment's proximal portion 12 is adapted to protect the downtube 40 and frame rails 38 from wear & tear occurring when debris strikes these items during an off-road riding session. In order to couple the proximal portion in an effective and efficient manner to the vehicle such that these vehicle items, among others, are protected, the proximal portion is typically coupled to the vehicle through two vehicle attachment mechanisms 18 located in the downtube section 20 of the embodiment. However the two vehicle attachment mechanisms may be located in the framerail section 22, or there may be more than two vehicle attachment mechanisms, with all, some, or none of the vehicle attachment mechanisms located in the downtube section.

In the typical embodiment, the vehicle attachment mechanisms 18 are bores. The bores are adapted to couple the embodiment to a vehicle mounting point, typically located on the vehicle fame. Oftentimes, the vehicle attachment mechanisms are adapted to receive a mounting point screw such that the screw couples the embodiment to the mounting point. The bores may or may not be threaded.

In one embodiment, a vehicle attachment mechanism 18 may not couple to a mounting point, but may couple to a different vehicle component. A vehicle attachment mechanism such as, but not limited to, a bore having a grommet adapted to receive a zip-tie or some other coupling mechanism to couple the embodiment to the vehicle frame. When grommets are used, the grommets may be brass grommets, but they may also be rubber, aluminum, or another type of grommet. Additional vehicle attachment mechanisms not using bores are also contemplated such as, but not limited to, a magnetic attachment mechanism.

The material used in one embodiment is one that imparts significant resiliency to the plate, such as, but not limited to, polyethylene, that is characterized as having a low modulus relative to most advanced composites and metals. Such materials are typically used for a myriad of reasons, such as, but not limited to (i) decreasing the weight of the vehicle as compared to a vehicle with a factory-installed skid plate, such as an aluminum skid plate; (ii) reducing the clean-up required after an off-road cycling session, as compared to a factory-installed skid plate, (iii) protecting the downtube 40, frame rails 38, linkage 34, and undercarriage from wear and tear; (iv) allowing the distal portion 16 to elastically deform relative to the position of the linkage, as described below, and (v) providing an adequate advertising section on the undercarriage 32 of the vehicle.

In one embodiment, the thickness 30 of the material in all portions and among portions is generally uniform. The typical thickness of the material when the material is polyethylene is generally 1/10 of an inch. However, in one embodiment, the thickness may be less than or greater than 1/10 of an inch. The thickness of the embodiment may be dependent upon the material, or it may be dependent upon other factors. For example, if a very low modulus material were used, such as polyisoprene, the thickness may be greater than 1/10 of an inch, such as ⅛, ¼, ½ or even 1 inch thick. Or, if a higher modulus material were used, such as, in a hinged version as described below using a composite, the thickness of the material may be less than 1/10 of an inch, such as, but not limited to a 1/12 or 1/16 inch thickness. Thicknesses may vary amongst and within portions as well, depending on or not depending on the type of material is used or the use or location of an embodiment.

The proximal portion 12 of an embodiment is typically integrated to the center portion 14 of an embodiment at any position in the embodiment after the frame rail expansion width 26. Typically, the integration occurs at a position where the width of the embodiment is at the maximum width 28, but prior to the centerline 42 of an embodiment. Oftentimes, the integration is adapted to occur, when the embodiment is placed on vehicle, where the front frame rails 38 curve to become the undercarriage frame rails. The center portion typically has the same thickness and is made of the same material as the proximal portion. Additionally, the center and proximal portions are adapted to enable sliding upon casing a jump.

The width 28 of the center portion 14 of one embodiment is generally uniform and equal to the maximum width 28 of the proximal portion 12. Also similar to the proximal portion, in one embodiment, the width of the center portion may vary either to protect the frame rails 38 as the frame rails vary in width, or to protect other components on the undercarriage of the vehicle, or for any other reason.

The center portion 14 in one embodiment typically has at least 2 vehicle attachment mechanisms 18. However, the center portion in an embodiment may possess 4, 6 or even 8 or more vehicle attachment mechanisms. Similar to the proximal portion's vehicle attachment mechanisms, the center portion's vehicle attachment mechanisms are typically bores adapted to couple to a mounting point. Also similar to the proximal portion 12, the vehicle attachment mechanisms may not be a bore, or may not couple to a vehicle mounting point, but may be a magnetic or any other attachment mechanism. The center portion is typically adapted to protect a vehicle's frame rails and undercarriage.

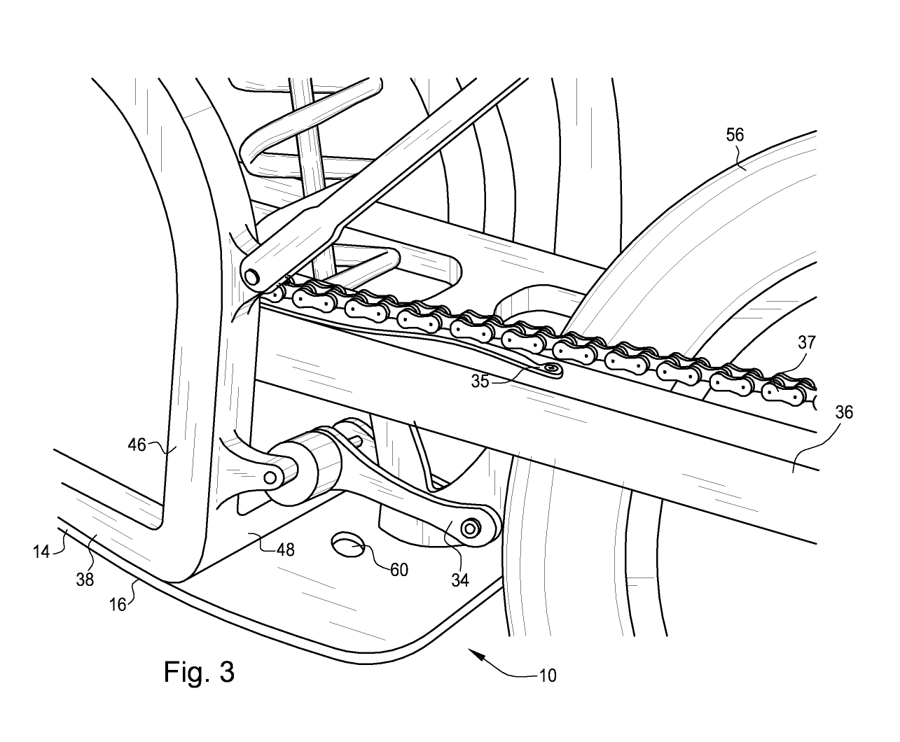

In one embodiment, the center portion 14 is typically integrated to the distal portion 18 after the embodiment centerline 42. As best shown in FIG. 3, one embodiment's center portion is adapted to integrate to an embodiment's distal portion proximal a vehicle's rear vertical frame rail 46 and rear horizontal frame rail 48. However, in an embodiment, the center and distal portions may also be adapted to integrate prior to, or after, the vehicle's rear vertical frame rail 46 and rear horizontal cross rail 48.

Typically, as best shown in FIG. 1, the distal portion 16 of one embodiment is comprised of two vehicle attachment mechanisms 18. The vehicle attachment mechanisms are typically located proximal the rear horizontal frame rail 48. As in the center portion 14 and proximal portion 12, each vehicle attachment mechanism is typically adapted to couple to a vehicle mounting point. In other embodiments, the two vehicle attachment mechanisms may be located in the center section or may not be adapted to couple to the rear horizontal frame rail 48 or a vehicle mounting point.

In addition to having two vehicle attachment mechanisms 18, in one embodiment, the distal portion may be comprised of an original width 50 that is typically equal to the maximum width 28 of the center portion 14 where the center and distal portions are integrated. However, the width of the distal portion in one embodiment varies. Specifically, the width of the distal portion of an embodiment may generally be decreased by 25% at a point in the embodiment after the distal portion's vehicle attachment mechanisms.

The width decrease may be adapted to occur at a location proximal a distal edge of the rear horizontal frame rail 48. As best shown in FIG. 1, the width of the distal portion may then continue to decrease—generally evenly until the distal portion end 52 is reached, with the distal portion end width 54 being generally 60% of the original width 50. In other embodiments, as best shown in FIG. 3, the original width of the distal portion is substantially equal to the distal end width. Additionally, in one embodiment, the distal portion width may be decreased generally uniformly from the center portion integration to the distal end.

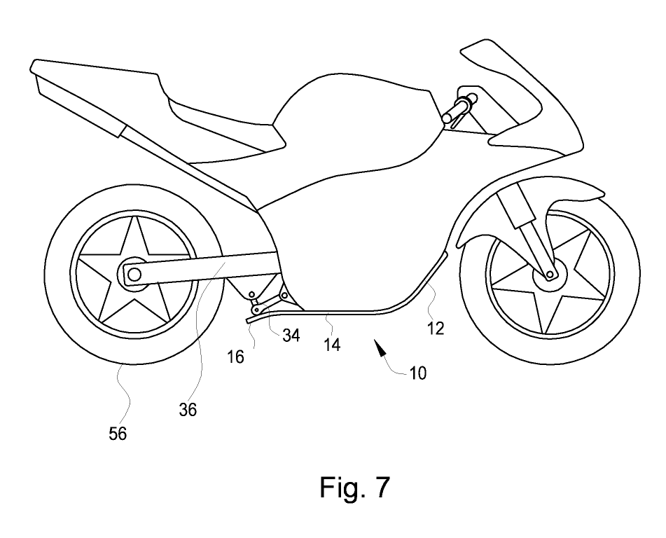

As best shown in FIG. 7, in one embodiment, the distal portion 16 is adapted to act as a pivot mechanism and angle in a downward direction, towards the rear wheel 56, and away from the center portion 14 when the vehicle is in a generally horizontal position. When the distal portion 16 is angled in a downward direction towards the rear wheel and away from the center portion, typically, at least a part of the distal portion contacts the linkage 34. The distal portion's contact with the linkage typically applies a force to the linkage in an upward vertical direction.

The force is applied to the linkage 34 by the distal portion 16 bending and typically pivoting on vehicle attachment mechanisms 18 located on the rear horizontal frame rail 48. Typically, the resiliency within the embodiment 10 attempts to substantially align the distal portion with a horizontal plane of the pivot point. Therefore, when the linkage 34 is located below the horizontal plane of the pivot point, as the distal portion attempts to align with the vehicle attachment mechanisms, part of the distal portion contacts at least a portion of the linkage, applying a force in a generally upwardly vertical direction. As the linkage is moved due to the swingarm movement, the resiliency keeps the distal portion substantially continually in contact with at least a portion of the linkage.

Linkage 34 movement typically occurs upon vehicle movement. For example, when the vehicle moves, the swingarm 36 typically pivots to adjust the rear wheel 56 up and down as the vehicle travels over bumps and holes in order to provide a more stable ride for the rider. The swingarm movement is adapted so that the rear wheel hub is moved in a substantially vertical plane. Likewise, as the swingarm is coupled to the linkage, the swingarm movement causes the linkage to also move in a substantially vertical direction. During this linkage movement, the distal portion resiliency keeps at least a portion of the distal portion substantially continually flushly in contact with at least a portion of the linkage, thereby providing substantial continual protection to the linkage.

In one embodiment, the resiliency in the material may also allow the distal portion 16 to substantially flushly contact at least a portion of the linkage when the linkage is located above the horizontal plane of the pivot point. For example, if the distal portion is angled in a substantially rearwardly upward angle from the center portion integration, the resiliency in the material will attempt to align the distal portion with the rearwardly upward vertical angle. In this manner, or in another manner, one embodiment may be adapted such that the distal portion substantially contacts the linkage in nearly any vertical linkage position.

The distal portion of an embodiment also typically includes a drain tube bore 60. The drain tube bore is adapted to allow vehicle engine drain tubes to pass through- an embodiment when the embodiment is coupled to the vehicle.

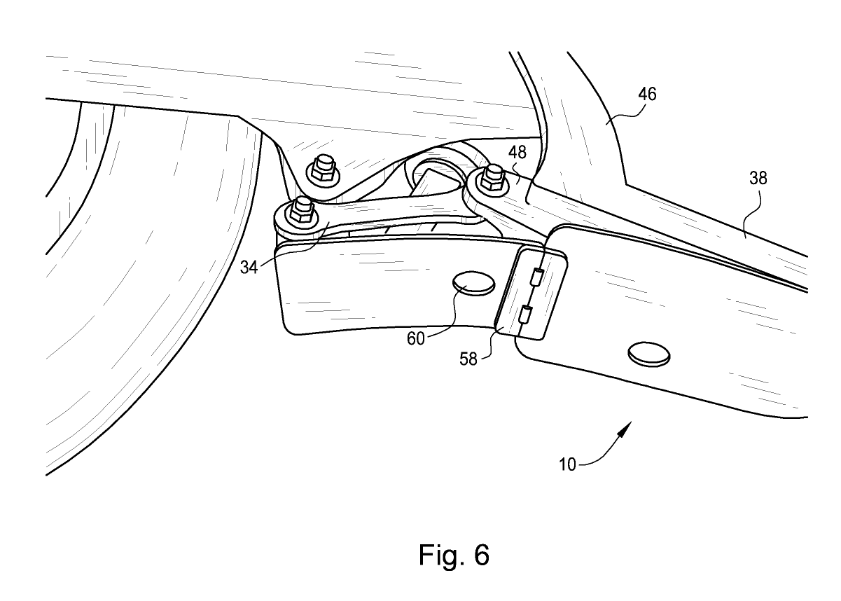

As best shown in FIG. 6, the distal potion 16 may also be substantially continually flush with at least a portion of the linkage 34 by use of a hinge 58. In a hinged version, the distal portion and the center portion 14 are coupled together via the hinge. The hinge may also be coupled to the vehicle. In one embodiment, at least a portion of the hinge may either comprise a portion of the center portion or a portion of the distal portion. In such an embodiment, at least a portion of the hinge may be a living hinge and at least a portion of the hinge may be a traditional hinge with an axis of rotation. Alternatively, substantially the entire hinge may be a traditional hinge, as best shown in FIG. 6, and in such an embodiment, the section comprising the distal portion or the center portion may also be generally rigid.

In one embodiment, the hinge 58 is a separate component that is coupled to the distal portion 16 and the center portion 14. In such an embodiment, the hinge is typically comprised of a relatively stiff material, such as, but not limited to, brass, aluminum, steel, or an alloy. Additionally, the center and distal portions in a hinge version may be comprised of a stiff material such as, but not limited to, a composite material, steel or a steel alloy, or aluminum or an aluminum alloy.

In one embodiment, the hinge 58 allows at least part of the distal portion 16 to substantially continually contact at least a portion of the linkage 34. For this to occur, similar to the resilient version of the embodiment, as the distal portion extends away from the center portion 14 and the hinge, the distal portion may be angled downward and towards the rear of the vehicle in order to protect the linkage when the linkage position is lower than the horizontal plane of the hinge coupling to the center portion.

Where the hinge 58 is either a separate component from the center portion 14 and distal portion 16, or, where the hinge is integrated into at least part of the center portion or distal portion, the hinge may be comprised of a spring or other force-inducing device. The spring or other force-inducing device is typically adapted to apply a substantially vertical force to the hinge component coupled to the distal portion. The hinge component, thereby, is adapted to keep the distal portion substantially continually contacting at least a portion of the linkage 34 as the linkage moves in vertical direction. Like the unitary resilient embodiment, the hinge embodiment may be adapted to apply a force to the linkage when the linkage position is above or below the horizontal plane that at least a portion of the hinge is located on.

In one embodiment of either the hinged version or the unitary resilient version, the center portion, proximal portion, or distal portion of the embodiment may be adapted to contain advertisements. The advertisements may be print advertisements such as, but not limited to, decals. The decals may be a word decal or may be a logo decal, or any other type of advertising. The advertisement may also be integrated into the embodiment.

### Second Embodiment of a Vehicle Linkage Skid Plate

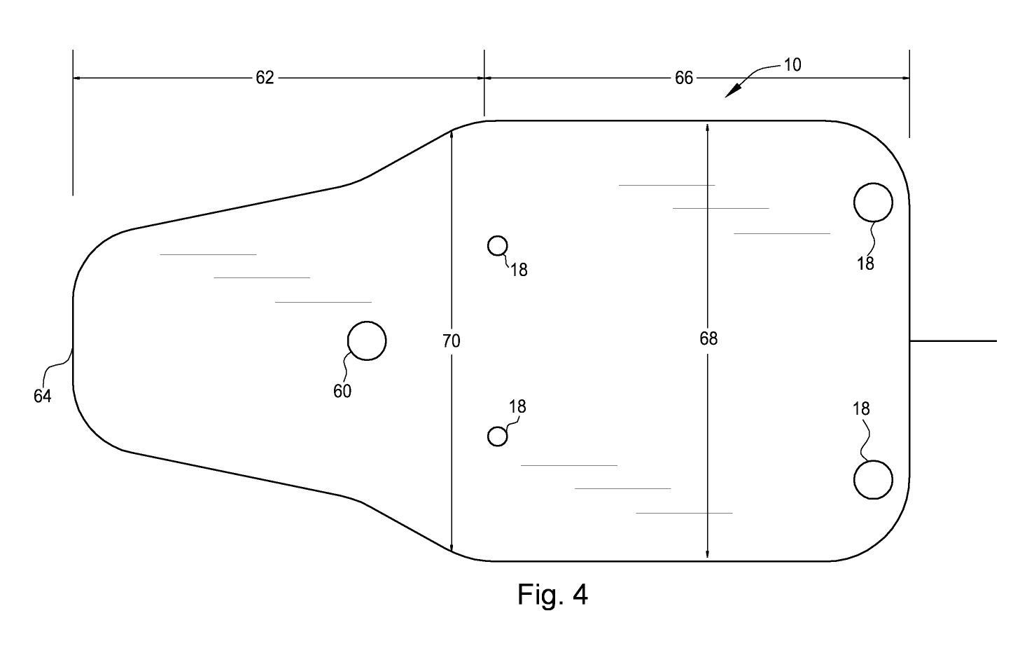

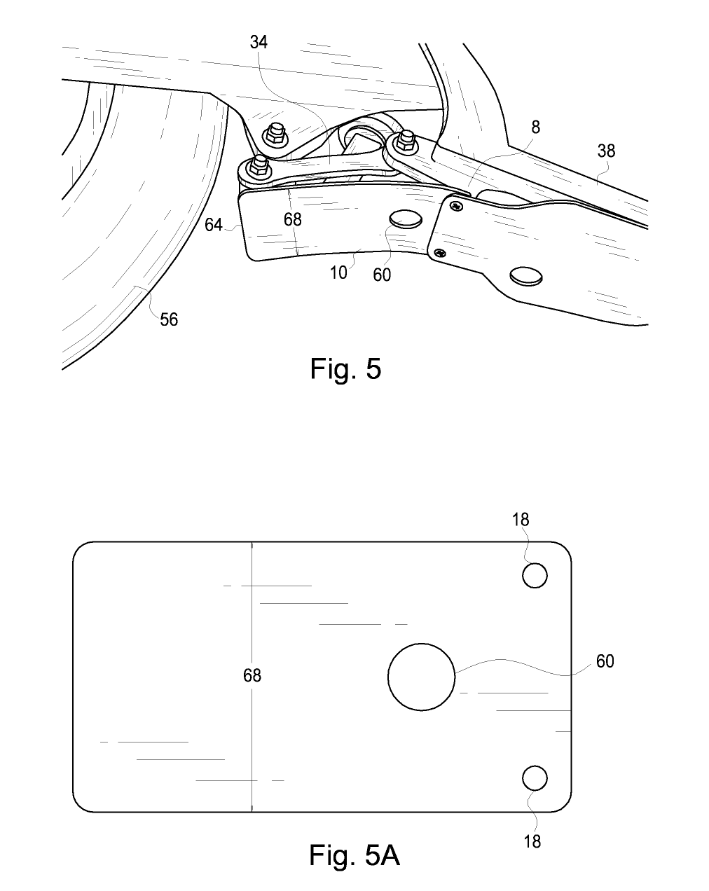

Referring to FIGS. 4 to 5A, one embodiment of a skid plate is typically comprised of single portion 10. The single portion 10 is similar to the distal portion of the first embodiment. The linkage 34 and at least a portion of the rear horizontal frame rail 48 are typically protected by an embodiment, while the undercarriage and the down tube are not typically protected. As best shown in FIG. 5, one version of the embodiment is typically coupled to and extends from the rear horizontal frame rail 48 towards the rear wheel 56.

An embodiment, as best shown in FIGS. 5 and 5A, is typically comprised of two vehicle attachment mechanisms 18 adapted to couple to two frame rail mounting points. However, as best shown in FIG. 4, an embodiment may be comprised of four vehicle attachment mechanisms. An embodiment may include a tapered portion 62, as best shown in FIG. 4.

The width 70 of the tapered portion 62 typically decreases from the vehicle attachment mechanisms 18 adapted to couple to the rear horizontal frame rail, to the distal end 64. Typically, the width at the distal end 64 is generally 75% of the width prior to the tapered portion. However, the width at the distal end may be generally greater than 75%, such as 90%, or may be generally less than 75%, such as 50%, of the pre-tapered portion width 68.

As best shown in FIG. 5, one embodiment does not taper. The width 68 of the non-tapered version and the width of the pre-tapered portion 66 of the tapered version are typically generally uniform and equal to the width of the frame rails 38 on the undercarriage of the vehicle. However, in one embodiment, the width of the pre-tapered portion and the non-tapered version may be neither generally uniform nor generally equal to the width of the frame rails. For example, one embodiment's width is generally equal to the width of the linkage 34 and not equal to the width of the frame rails.

One embodiment includes a drain tube bore 60. As in the first embodiment, the drain tube bore is adapted to allow vehicle drain tubes to be connected to the vehicle without the need to dismantle or remove the embodiment.

One embodiment is adapted to protect the linkage 34 in substantially the same manner as one first embodiment protects the linkage. In one embodiment, a flexible material is used to protect the linkage. The embodiment may extend down and away from the vehicle attachment mechanisms 18 towards the rear wheel 56 and terminating in a distal end 64. As stated in the first embodiment, the embodiment must angle downward from the vehicle attachment mechanisms 18 because a vehicle's linkage 34 is often located below the horizontal plane that the vehicle attachment mechanisms 18 are located on.

In order to protect linkage 34 located below the horizontal plane of the vehicle attachment mechanisms 18, an embodiment typically pivots on the vehicle attachment mechanisms in order to cover the linkage. Due to the resilient properties of the skid plate embodiment, one embodiment typically attempts to substantially align the entire single portion with the horizontal plane that the pivoting vehicle attachment mechanisms are located on. Therefore, when the linkage is below this horizontal plane, the embodiment typically contacts at least a portion of the linkage.

As the linkage 34 raises and lowers comporting to the raising and lowering of the swingarm as described in the first embodiment, the embodiment moves relative to the linkage movement by substantially continually contacting the linkage. If the linkage moves higher than the horizontal plane of the vehicle attachment mechanisms 18, as described in the first embodiment, the embodiment may be adapted so the resiliency in the material aligns the embodiment with a plane angled rearwardly and upwardly from the pivoting vehicle attachment mechanism. For example, the embodiment may be angled after the pivoting vehicle attachment mechanisms rearwardly upward in order for the distal end to align with a horizontal plane higher than the horizontal plane of the vehicle attachment mechanisms.

The embodiment may also include a hinge. The hinge is adapted to protect the linkage in substantially the same manner as the hinge in the first embodiment.

### One Method of Protecting a Vehicle's Rear Suspension Linkage:

One method of protecting a vehicle's rear suspension linkage includes installing a resilient linkage skid plate on a vehicle. The installation may include removal of any skid plate that is already attached to the vehicle. However, the installation of a linkage skid plate may not require removal of a skid plate already attached to the vehicle.

The installation typically includes coupling the skid plate to a plurality of vehicle mounting points. The mounting points are typically located on the vehicle frame and may be comprised of a screw. The screw is adapted to be placed through a vehicle attachment mechanism. The vehicle attachment mechanism is typically a bore in an embodiment.

Additionally, the method includes ensuring the linkage skid plate is substantially flush with the rear linkage. Typically, during the installation of an embodiment, at least a portion of the skid plate is placed flush with at least a portion of the linkage. Also, the method includes ensuring that the skid plate is placed proximal although not touching, the rear wheel.

One method is also comprised of moving the linkage in a substantially vertical direction. The linkage typically moves in a vertical direction when the vehicle travels over bumps or holes. When the vehicle travels over these items, the swingarm is adapted to adjust the rear wheel up or down to provide a smoother ride to the rider. Once the swingarm moves up or down, the linkage moves up or down relative to the swingarm. Likewise, the skid plate moves up or down relative to the position of the linkage in order to adequately protect the linkage from rocks, dirt, and debris.

The skid plate typically moves to a position relative to the position of the linkage by substantially continually contacting a portion of the linkage. Typically, the skid plate is a unitary piece of a thin resilient polymer plate that upwardly pivots on a vehicle mounting point located at a vertical position higher than the linkage. In one method, the skid plate extends from the attachment mechanisms downward and towards the rear wheel in order to cover the linkage.

In a method, the resilient qualities of the skid plate attempt to substantially align the portion of the embodiment that is below the pivot point with the horizontal plane of the pivot point. Therefore, as the linkage moves in a vertical direction, the portion of the embodiment which contacts the linkage moves with the linkage to the horizontal plane of the pivot point. The embodiment may also be adapted to align with a horizontal plane at a vertical position higher than the pivot point. This vertical movement of the embodiment typically protects the linkage from at least some rocks, dirt, and debris from striking the linkage.

The method may also include inserting vehicle drainage tubes though a bore located in an embodiment and removing the skid plate from the vehicle.

### Alternative Vehicle Reflector Embodiments

The embodiments of the resilient skid plate as illustrated in the accompanying figures and described above are merely exemplary and are not meant to limit the scope of the invention. It is to be appreciated that numerous variations to the invention have been contemplated as would be obvious to one of ordinary skill in the art with the benefit of this disclosure. For instance, the embodiments are described herein primarily in relation to a resilient skid plate coupled to the bottom of an off-road pick-up truck.

I claim:

1) A skid plate comprising:
a proximal portion, a center portion, and a distal portion;
a pivot mechanism;
at least one vehicle attachment mechanism adapted to couple the skid plate to a vehicle.

2) The skid plate of claim 1 wherein,
the proximal portion, center portion, and distal portion comprising portions of a single unitary resilient embodiment;
the proximal portion being adapted to protect at least a portion of a motorcycle (i) downtube, (ii) frame rails, and (iii) casing; and
integrated to the center portion;
the center portion being adapted to protect at least a portion of a motorcycle frame rails and casing and integrated to the distal portion;
the distal portion being adapted to protect at least a portion of a motorcycle (i) linkage, (ii) chain roller, and (iii) chain; and
at least one attachment mechanism being (i) adapted to couple to a vehicle mounting point, and (ii) comprising at least a portion of the pivot mechanism.

3) The skid plate of claim 1 wherein,
the proximal portion integrated to the center portion;
the center portion and distal portion coupled to the pivot mechanism;
the pivot mechanism comprising a hinge,
the hinge being adapted to allow at least a part of the distal portion to contact at least a part of the vehicle suspension linkage; and
at least one of the attachment mechanisms adapted to couple to a vehicle mounting point.

4) The skid plate of claim 1 wherein,
the proximal portion, center portion, and distal portion comprising a single unitary resilient embodiment;
the proximal portion and the center portion protecting at least a portion of a vehicle frame and having vehicle attachment mechanisms adapted to couple to a vehicle mounting point; and
the distal portion being adapted to flexibly pivot relative to the position of a rear vehicle suspension linkage.

5) The skid plate of claim 4 wherein,
at least a section the proximal portion further protecting at least a portion of a vehicle downtube, the section being substantially equal to the width of the downtube;
at least a section of the center portion being substantially equal to the width of a vehicle frame rail; and
the resilient material being polyethylene 1/10 of an inch in thickness,

6) The skid plate of claim 5 wherein,
the proximal and center portions being adapted to enable sliding upon casing a jump; and
the distal portion having a distal end proximal the rear wheel.

7) The skid plate of claim 1 wherein,
the pivot mechanism adapted to substantially continually place the distal portion in contact with the linkage,

8) The skid plate of claim 7 wherein the skid plate protects at least a portion of a motorcycle (i) frame rails, (ii) casing, and (iii) linkage.

9) The skid plate of claim 8, further including protection of a motorcycle (i) downtube, (ii) chain roller, and (iii) chain.

10) A skid plate comprising:
a resilient material;
at least one vehicle attachment mechanism; and
a single portion adapted to protect a vehicle linkage.

11) The skid plate of claim 10 wherein:
the resilient material is polyethylene;
the single portion is adapted to protect the linkage by pivoting on at least one vehicle attachment mechanism.

12) The skid plate of claim 11 wherein:
the single portion is at least as wide as the linkage.

13) The skid plate of claim 11 wherein:
the at least one vehicle attachment mechanism is two vehicle attachment mechanisms, the two attachment mechanisms adapted to couple to two vehicle mounting points; and
the pivoting is adapted to substantially continually position the single portion in contact with the linkage.

14) The skid plate of claim 13 further including a bore, the bore being adapted to receive vehicle drainage tubes.

15) A method of protecting a vehicle linkage comprising:
installing a linkage skid plate on a vehicle;
ensuring the linkage skid plate is substantially flush with rear linkage.

16) The method of claim 15 further including:
moving the linkage in a substantially vertical direction;
moving the linkage skid plate relative to the linkage position.

17) The method of claim 16 further including:
at least a portion of the linkage skid plate substantially continually contacting at least a portion of the linkage.

18) The method of claim 17 further including:
protecting the linkage from rocks.

19) The method of claim 15 further including:
inserting vehicle drainage tubes though a bore.

20) The method of claim 18 further including:
removing the skid plate from the vehicle.
